(19) United States
(12) Patent Application Publication
(10) Pub. No.: US 2007/0203703 A1
(43) Pub. Date: Aug. 30, 2007

(54) Speech Synthesizing Apparatus

(75) Inventor: Daisuke Yoshida, Hyogo (JP)

Correspondence Address: JORDAN AND HAMBURG LLP, 122 EAST 42ND STREET, SUITE 4000, NEW YORK, NY, 10168, US

(73) Assignee: AI, Inc., Tokyo (JP)

(21) Appl. No.: 10/592,071

(22) PCT Filed: Mar. 29, 2005
(86) PCT No.: PCT/JP05/05815

§ 371 Date: Sep. 7, 2006

(30) Foreign Application Priority Data
Mar. 29, 2004 (JP) 2004-094071

(51) Int. Cl. G10L 13/08

(52) U.S. Cl. 704/260

(57) ABSTRACT

A corpus-based speech synthesizing apparatus is provided which has a text analysis unit for analyzing a given sentence in text data and generating phonetic symbol data corresponding to the sentence; a prosody estimation unit for generating a prosodic parameter representing an accent and an intonation corresponding to each phonetic symbol data according to a preset prosodic knowledge base for accents and intonations; speech-unit extraction unit for extracting all the speech segment waveform data of a predetermined speech unit part from each speech data having the predetermined speech unit part closest to the prosodic parameter, based on a speech database which stores therein plural kinds of predetermined selectively prerecorded speech data only such that the speech database has a predetermined speech unit suitable for a specific application of the speech synthesizing apparatus; and a waveform connection unit for generating synthesized speech data by performing sequentially successive waveform connection of the speech segment waveform data groups such that the speech waveform of the speech segment waveform data groups continues, wherein the respective functional units, a data input unit, a speech conversion processing unit, and a speech speed conversion unit is added or removed as desired depending on a specific application and a scale of the apparatus.

### TECHNICAL FIELD

The present invention relates to a speech synthesizing apparatus. More particularly, the present invention relates to a speech synthesizing apparatus that is an embedded micro computer installed in a separate apparatus, wherein the speech synthesizing apparatus contains a speech database in which multiple types of prerecorded speech data of predetermined texts that have been stored on a predetermined speech unit basis and the speech synthesizing apparatus is adapted to perform corpus-based speech synthesis with respect to a given set of text data based on the speech database.

### BACKGROUND ART

Conventionally, speech synthesis technology includes: cut-and-paste speech synthesis, used for applications such as public address announcements at train stations, wherein a sentence is speech-output by a machine by combining prerecorded words and phrases used as sound sources; and rule-based speech synthesis, used for applications such as automated telephone guidance, wherein sound data near a certain speech waveform is stored on a letter-by-letter basis and this single sound data is connected by signal processing and output as a speech waveform close to that of a natural voice.

For cut-and-paste speech synthesis, however, only combinations of the prerecorded phrases are possible. Therefore, the number of synthesizable sentences is limited. Furthermore, when synthesis of a new sentence is desired, sound sources for words and phrases used for this additional sentence must be recorded, which results in a necessary expense. Thus, cut-and-paste speech synthesis has a low readout capacity for outputting various sentences as desired.

In the case of rule-based speech synthesis, a sound closer to the speech waveform of a natural voice is synthesized by connecting sound data corresponding to respective single letters by signal processing and then successively sequencing single sounds, while ignoring differences in context and word nuance. Therefore, the resulting output sound is mechanical and of poor quality. Such mechanical sounds are far removed from natural vocalization and cause discomfort for listeners.

Thus, recently, there has been known corpus-based speech synthesis technology, for example, as disclosed in Japanese Patent Nos. 2894447 and 2975586, wherein a large number of sentences recorded in a natural human voice are compiled into a database beforehand and the database (corpus) of the enormous amount of speech data are used as a sound source for synthesizing a speech.

In the corpus-based speech synthesis technology disclosed in Japanese Patent Nos. 2894447 and 2975586, it is possible to extract necessary phonemes from many sentences recorded in the database and synthesize a lot of sentences by combining these phonemes. As a result, the number of synthesized sentences which can be output is enormous. Further, a natural human voice is employed as its sound source, so that a natural speech closer to a natural human voice can be output than a synthesized speech produced by using a machine voice.

Furthermore, according to the corpus-based speech synthesis technology disclosed in Japanese Patent Nos. 2894447 and 2975586, even when a new sentence is additionally synchronized, such sentence can be synchronized by the use of the phonemes in the prerecorded sound source. Thus, additional recording for the database is not required, so that no additional cost is necessary. Accordingly, this technology is currently being introduced in call centers and the like.

### DISCLOSURE OF INVENTION PROBLEM TO BE SOLVED BY INVENTION

For the conventional corpus-based speech synthesis technology, however, the database storing therein sentences containing a lot of phonemes in order to adapt certain sentence synchronization has become enormous, which results in upsizing of an apparatus therefor. For example, when such an apparatus is introduced in a call center or the like, databases dedicated for respective applications, for example, for business content, a brochure request, a target department, etc. should be assembled.

In addition, since the apparatus becomes large, it is difficult to be incorporated in small products including medical and welfare devices for hard-of-hearing persons, toys, household electrical appliances and the like. Thus, the applications of this technology has been limited to a call center and the like, and introduction thereof has been limited to companies and the like having large-scale equipment.

In view of the foregoing, objects of the invention to be achieved by the present invention are as follows.

Specifically, a first object of the invention is to reduce the size of apparatuses for performing the corpus-based speech synthesis and provide a speech synthesizing apparatus which can be incorporated in a separate apparatus.

A second object of the invention is to provide a removable speech synthesizing apparatus having a speech database used for corpus-based speech synthesis, which speech database stores therein speech data selectively recorded for a specific application.

Other objects of the invention will appear more clearly from the following description, the accompanying drawings, and especially from each of the appended claims.

### MEANS FOR SOLVING PROBLEMS

Characteristically, an apparatus of the invention is a speech synthesizing apparatus which is an embedded micro computer installed in a separate apparatus, the speech synthesizing apparatus comprising: a text analysis unit for analyzing a given sentence in text data and generating phonetic symbol data corresponding to the sentence; a prosody estimation unit for generating a prosodic parameter representing an accent and an intonation corresponding to each phonetic symbol data of the sentence analyzed by the text analysis unit according to a preset prosodic knowledge base for accents and intonations; speech-unit extraction unit for extracting all the speech segment waveform data of an associated predetermined speech unit part from each speech data having the predetermined speech unit part closest to the prosodic parameter generated by the prosody estimation unit, based on a speech database which stores therein plural kinds of predetermined selectively prerecorded speech data only such that the speech database has a predetermined speech unit suitable for a specific application of the speech synthesizing apparatus; and a waveform connection unit for generating synthesized speech data by performing, in a sequence of sentences, sequentially successive waveform connection of the speech segment waveform data groups extracted by the speech-unit extraction unit such that the speech waveform of the speech segment waveform data groups continues.

Specifically and particularly, the problems of the invention are solved such that the foregoing objects are achieved by employing the following novel characteristic features from the super-ordinate conception to the subordinate conception.

That is, a first feature of the apparatus of the present inventions is to employ a structure of a speech synthesizing apparatus which is provided with a speech database that stores plural kinds of prerecorded speech data of predetermined sentences such that the speech data can be extracted as speech segment waveform data for each predetermined speech unit, and which is provided for performing corpus-based speech synthesis based on a speech database with respect to a given text data, the speech synthesizing apparatus comprising: data input unit for acquiring text data from serial data; a text analysis unit for processing the sentence in the text data so as to represent sounds corresponding to the sentence by phonetic symbols of vowels and consonants and generating phonetic symbol data of the sentence; a prosody estimation unit for generating a prosodic parameter representing an accent and an intonation corresponding to each phonetic symbol data corresponding to a given sentence in the text data which was analyzed beforehand according to a preset prosodic knowledge base for accents and intonations; speech-unit extraction unit for extracting all the speech segment waveform data of an associated predetermined speech unit part from each speech data having the predetermined speech unit part closest to the prosodic parameter generated by the prosody estimation unit, based on a speech database which stores therein plural kinds of predetermined selectively prerecorded speech data only such that the speech database has a predetermined speech unit suitable for a specific application of the speech synthesizing apparatus; a waveform connection unit for generating synthesized speech data by performing, in a sequence of the sentences, sequentially successive waveform connection of the speech segment waveform data groups extracted by the speech-unit extraction unit such that the speech waveform of the speech segment waveform data groups continues; and speech conversion processing unit for converting the synthesized speech data to analog sounds and outputting the analog sounds.

A second feature of the apparatus of the present inventions is to employ a structure of a speech synthesizing apparatus wherein the speech database according to a first feature of the present apparatus is assembled on a memory card which can be removably mounted to the speech synthesizing apparatus, and when the memory card is mounted to the speech synthesizing apparatus, the memory card can be read from the speech-unit extraction unit.

A third feature of the apparatus of the present invention is to employ a structure of a speech synthesizing apparatus wherein the data input unit according to a first feature of the present apparatus is connected to a separate apparatus in which the speech synthesizing apparatus is incorporated and the data input unit receives serial data from the separate apparatus.

A fourth feature of the apparatus of the present invention is to employ a structure of a speech synthesizing apparatus wherein the synthesizing apparatus according to a first feature of the present apparatus reflects a speed parameter acquired together with the given sentence from the data input unit to the synthesized speech data generated by the waveform connection unit, and a speech speed conversion unit for adjusting a read speed of the synthesized speech data is placed upstream from the speech conversion processing unit.

A fifth feature of the apparatus of the present invention is to employ a structure of a speech synthesizing apparatus wherein the data input unit, the text analysis unit, the prosody estimation unit, the speech database, the speech-unit extraction unit, the waveform connection unit, and the speech conversion processing unit according to a first feature of the present apparatus are integrally installed in a single casing.

A sixth feature of the apparatus of the present invention is to employ a structure of a speech synthesizing apparatus wherein the waveform connection unit and the speech conversion processing unit according to a first feature of the present apparatus are integrally mounted in an embedded micro computer which is installed in a separate apparatus; the data input unit, the text analysis unit, the prosody estimation unit, the speech database and the speech-unit extraction unit are mounted in a personal computer in a center; the embedded micro computer and the personal computer in the center are independently connected to the same network; and the embedded micro computer and the personal computer in the center are composed as a system wherein, in the personal computer in the center, the text data passing through the data input unit, the text analysis unit, the prosody estimation unit and the speech-unit extraction unit that is directly connected to the speech databaseis converted to the speech segment waveform data at the speech-unit extraction unit, so that the speech segment waveform data cab be transmitted to the waveform connection unit in the embedded micro computer through the network and then synthesized speech is delivered from the waveform connection unit to the speech conversion processing unit in the embedded micro computer.

A seventh feature of the apparatus of the present invention is to employ a structure of a speech synthesizing apparatus wherein the speech synthesizing apparatus according to a first feature of the present apparatus is configured such that the data input unit is connected to a separate given personal computer and the input unit can acquire the text data to be analyzed by the text analysis unit from the personal computer, and such that the speech synthesizing apparatus is connected to a separate given speaker which is provided as the speech conversion processing unit and the synthesized speech data generated by the waveform connection unit can be speech-output by the speaker.

A eighth feature of the apparatus of the present invention is to employ a structure of a speech synthesizing apparatus wherein the predetermined speech unit according to a first feature of the present apparatus is one or more of a phoneme, a word, a phrase and a syllable.

A ninth feature of the apparatus of the present invention is to employ a structure of a speech synthesizing apparatus wherein each of the data input unit and the text analysis unit according to a first feature of the present apparatus has an initial setup function for, when mounted to a personal computer for use only when an initial setup time, inputting serial data and outputting phonetic symbol data; the prosody estimation unit, the speech database, the speech-unit extraction unit, the waveform connection unit and the speech conversion processing unit are mounted in an embedded computer which is installed in a separate apparatus; the personal computer is connected to the embedded micro computer only when the initial setup time, the phonetic symbol data output from the personal computer is input to the prosody estimation unit in the embedded micro computer, some data is prerecorded in the speech database, serial data input in the embedded micro computer is analog-output from speech conversion processing unit passing through the prosody estimation unit; the speech-unit extraction unit is directly connected the speech database; and the waveform connection unit in this order.

A tenth feature of the apparatus of the present invention is to employ a structure of a speech synthesizing apparatus wherein the waveform connection unit and the speech conversion processing unit according to a first feature of the present apparatus are installed in an output terminal used for emergency alert, guide or notification as embedded micro computers; and the data input unit, the text analysis unit, the prosody estimation unit, the speech database and the speech-unit extraction unit are incorporated in a personal computer in a center, and the personal computer and the embedded micro computer constitute a system which can transmit data in only one direction through a network.

A eleventh feature of the apparatus of the present invention is to employ a structure of a speech synthesizing apparatus wherein the prosody estimation unit, the speech database, the speech-unit extraction unit, the waveform connection unit and the speech conversion processing unit according to a first feature of the present apparatus are separated from the data input unit and the text analysis unit after initial setup, and installed as an embedded micro computer in a toy or a separate apparatus.

### ADVANTAGEOUS EFFECT OF INVENTION

Thus, according to the present invention, the speech synthesizing apparatus is provided with an embedded micro computer and it becomes possible to significantly reduce the size of speech synthesizing apparatuses employing corpus-based speech technology, compared with conventional ones which could not avoid upsizing heretofore. As a result, the apparatus of the invention can be incorporated in a separate apparatus. Thus, for example, the apparatus of the invention may be incorporated in medical and welfare devices so as to be used as a communication tool which enables transmission of sounds. Further, the apparatus of the invention may also be applied to various products including toys such as dolls which can output a character's voice; and household electrical appliances which can transmit information by speech.

In addition, the speech database is assembled on a removable memory card, which enables to replace the speech database depending on a specific application. As a result, the speech synthesizing apparatus can be reduced in size. Further, by recording speech data suitable for a specific application, speech synthesis accuracy rates of reading and accent can be enhanced, and thereby more natural speech can be output. Furthermore, it becomes possible to change a type of output voice to a user's favorite type.

Conventionally, when speech synchronization is performed using a network, a high and middle speed line is used for transmitting sounds. According to the invention, however, it suffices to receive text data by a destination device and convert the text data to sound data, such that sound broadcasting using a low speed line becomes possible. Further, when the present invention is applied to a push type service, delivery of text data only causes to enable the destination device to output the text data as sound data, which contributes to a labor saving. Furthermore, even when an emergency is expected for disaster radio or the like, prompt service can be ensured.

### BRIEF DESCRIPTION OF DRAWINGS

FIG. 1 is a functional block diagram of a speech synthesizing apparatus according to an exemplary form of the invention;

FIG. 2 is a functional block diagram of a speech synthesizing apparatus provided by adding a speech speed conversion unit to the speech synthesizing apparatus shown in FIG. 1;

FIG. 3 is a schematic view showing an exemplary hardware configuration of the speech synthesizing apparatus in FIG. 1;

FIGS. 4 (a)-4(e) are diagrams for illustrating the data configuration of the speech synthesizing apparatus in FIG. 1, wherein FIG. 4(a) is a diagram for illustrating text data; FIG. 4(b) for phonetic symbol data; FIG. 4(c) for prosodic knowledge base; FIG. 4(d) for prosodic parameters; and FIG. 4(e) for a speech database;

FIG. 5 is a functional block diagram of a speech synthesizing apparatus according to an exemplary functional configuration 2 of the invention;

FIG. 6 is a functional block diagram of a speech synthesizing apparatus according to a exemplary functional configuration 3 of the invention; and

FIG. 7 is a schematic diagram showing an exemplary hardware configuration wherein the speech synthesizing apparatus according to the embodiment of the invention is installed in a personal computer.

### DESCRIPTION OF REFERENCE NUMERALS

α, α1 speech synthesizing apparatus

α2, α3 embedded micro computer

β, β2, β3 personal computer

γ speech synthesis system

1 speech database

2 text analysis unit

3 prosody estimation unit

3A prosodic knowledge base

4 speech-unit extraction unit

5 waveform connection unit

6 data input unit

7 speech conversion processing unit

8 speech speed conversion unit

11 CPU

12 ROM

13 RAM

14 memory card

15 serial interface

16 D/A converter

21 input means

22 speaker

### BEST MODE FOR CARRYING OUT THE INVENTION

In the following description of an embodiment of the invention, exemplary forms of a speech synthesizing apparatus will be described with reference to the accompanying drawings.

(Exemplary Form)

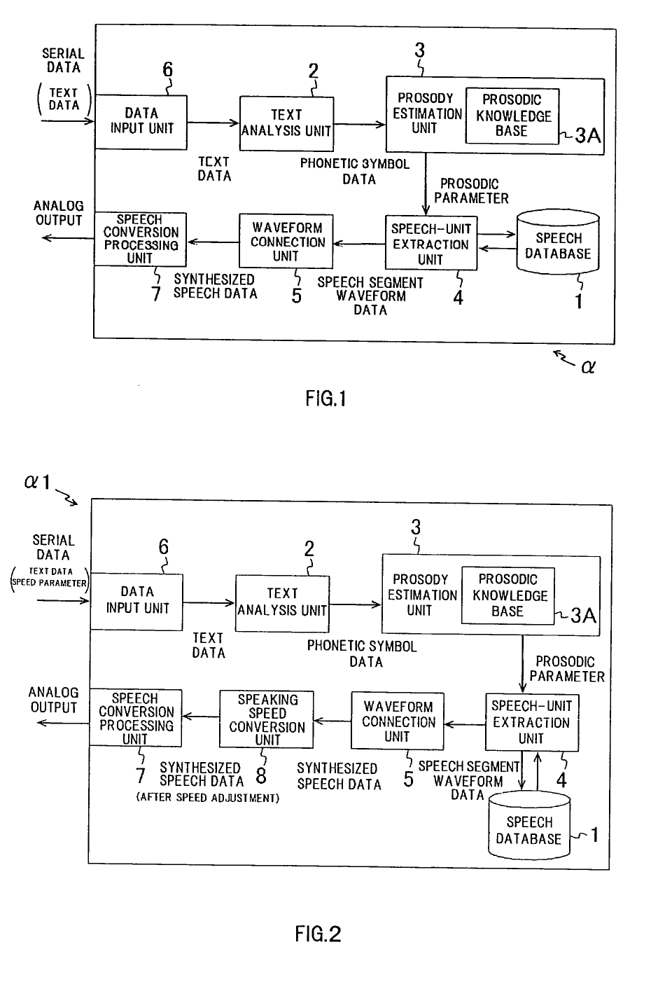

First, FIG. 1 is a functional block diagram of a speech synthesizing apparatus according to one exemplary form of the invention.

As shown in FIG. 1, a speech synthesizing apparatus α according to this exemplary form is provided with a speech database which stores a plurality kinds of prerecorded speech data of predetermined sentences such that the data can be extracted as speech segment waveform data for each predetermined speech unit such as a phoneme, a word, a phrase, a syllable and the like. Specifically, the speech synthesizing apparatus α is an apparatus for performing corpus-based speech synthesis based on a speech database 1 with respect to a given text data. It is composed of at least a text analysis unit 2, a prosody estimation unit 3, a speech-unit extraction unit 4 and a waveform connection unit 5, and is provided as an embedded micro computer which is installed in a separate apparatus as required.

It should be understood, however, that the micro computer does not have to be limited to have all of the aforementioned functional units. The micro computer may be provided with some predetermined functional units depending on its applications and scale, and the functions of the remaining functional units are designed to be performed by a personal computer.

As used herein, the speech database 1 is a corpus for performing corpus-based speech synthesis. The speech database 1 is assembled by storing therein only plural kinds of predetermined speech data which was selectively prerecorded such that only a predetermined speech units corresponding to the application of the speech synthesizing apparatus α are contained; and dedicating the speech database 1 depending on the application of the speech synthesizing apparatus α.

Further, the text analysis unit 2 is adapted to analyze a given sentence in input text data and generate phonetic symbol data corresponding to this sentence. The prosody estimation unit 3 has therein a prosodic knowledge base 3A to which a recognition rule regarding the accent and intonation of the phonetic symbol data is preset. Specifically, the prosody estimation unit 3 is adapted to generate a prosodic parameter indicating an accent and an intonation corresponding to each phonetic symbol data generated by the text analysis unit in accordance with the prosodic knowledge base 3A.

Furthermore, the speech-unit extraction unit 4 is adapted to extract from the speech database 1 the speech data which contains phonemes having an accent and an intonation that are closest to the respective prosodic parameters generated by the prosody estimation unit 3 by the use of, for example, an evaluation function that is made closer to the human auditory property, and then further extract only the speech segment waveform data of a predetermined speech unit (such as a phoneme corresponding to the prosodic parameter) from each speech data now extracted from the speech database 1.

In addition, the waveform connection unit 5 is adapted to generate synthesized speech data with a natural prosody by performing sequentially successive waveform connection of the speech segment waveform data groups extracted by the speech-unit extraction unit 4 such that the speech waveform of the speech segment waveform data groups can provide a smooth natural speech in a sequence of the sentences.

The embedded micro computer, i.e., the speech synthesizing apparatus α, may further comprise a data input unit 6 which is connected to a separate apparatus in which the speech synthesizing apparatus α is installed. The data input unit 6 may be adapted to receive serial data, for example, from an input means such as a keyboard or a mouse, or from a recording medium or the like for recording data that is transmitted and are received through a network; obtain text data from the serial data; and input the obtained text data to the text analysis unit 2.

When provided with this data input unit 6, the speech synthesizing apparatus α can perform the speech synthesis of the preset text data as well as the speech synthesis, for example, of a given sentence input by a user of the speech synthesizing apparatus α. In this way, the speech synthesizing apparatus α can accommodate the input of a given text data from a user and can satisfy the real-time requirements such as for always receiving a desired sentence and immediately outputting the sentence as the synthesized speech.

The embedded micro computer, i.e., the speech synthesizing apparatus α, may further comprise a speech conversion processing unit 7 for speech-outputting the synthesized speech data by converting the synthesized speech data generated by the waveform connection unit 5 to analog form, and outputting the resulting speech data to a speaker or the like connected thereto separately.

When an interface, a converter or the like having a similar function as that of the data input unit 6 and the speech conversion processing unit 7 and alternative thereto are installed in the separate apparatus in which the speech synthesizing apparatus α is incorporated, the speech synthesizing apparatus α may be adapted to be able to acquire text data and to speech-output synthesized speech data without containing therein the data input unit 6 and the speech conversion processing unit 7.

FIG. 2 is a block diagram of the speech synthesizing apparatus α in FIG. 1 to which a speech speed adjustment function is added.

As shown in FIG. 2, the micro computer, i.e., the speech synthesizing apparatus α1 may further comprise a speech speed conversion unit 8 for reflecting a speed parameter, which is input thereto together with text data from a separate apparatus in which the speech synthesizing apparatus α1 is installed, to the synthesized speech data generated by the waveform connection unit 5 and thereby adjusting the read speed of the synthesized speech.

FIG. 3 is a schematic view showing an exemplary hardware configuration of the speech synthesizing apparatus α illustrated as the particular exemplary form.

As shown in FIG. 3, the speech synthesizing apparatus α may further comprise a central processing unit (CPU) 11 for collectively controlling the respective functional units of the speech synthesizing apparatus α; a read only memory (ROM) 12 which is accessible from the CPU 11; a random access memory (RAM) 13. For example, it is desirable that a real time operating system (OS), a processing program and the like are recorded on the ROM 12, wherein the processing program is for causing the CPU 11 of the speech synthesizing apparatus α to perform the respective functions of the text analysis unit 2, prosody estimation unit 3, speech-unit extraction unit 4, and waveform connection unit 5.

Desirably, the speech synthesizing apparatus α further comprises a memory card 14 which is composed of a flash memory or the like and is removably installed to the speech synthesizing apparatus α, wherein, by assembling the speech database 1 on this memory card 14, it becomes possible to replace one memory card 14 to another desired memory card 14 depending on the preference of a user using the speech synthesizing apparatus α as the application of a separate apparatus in which the speech synthesizing apparatus α is installed, and the speech-unit extraction unit 4 functions based on the speech database 1 in the installed memory card 14.

In addition, the speech synthesizing apparatus α further comprises a serial interface 15 which functions as the data input unit 6 and a digital to analog (D/A) converter 16 which functions as the speech conversion processing unit 7.

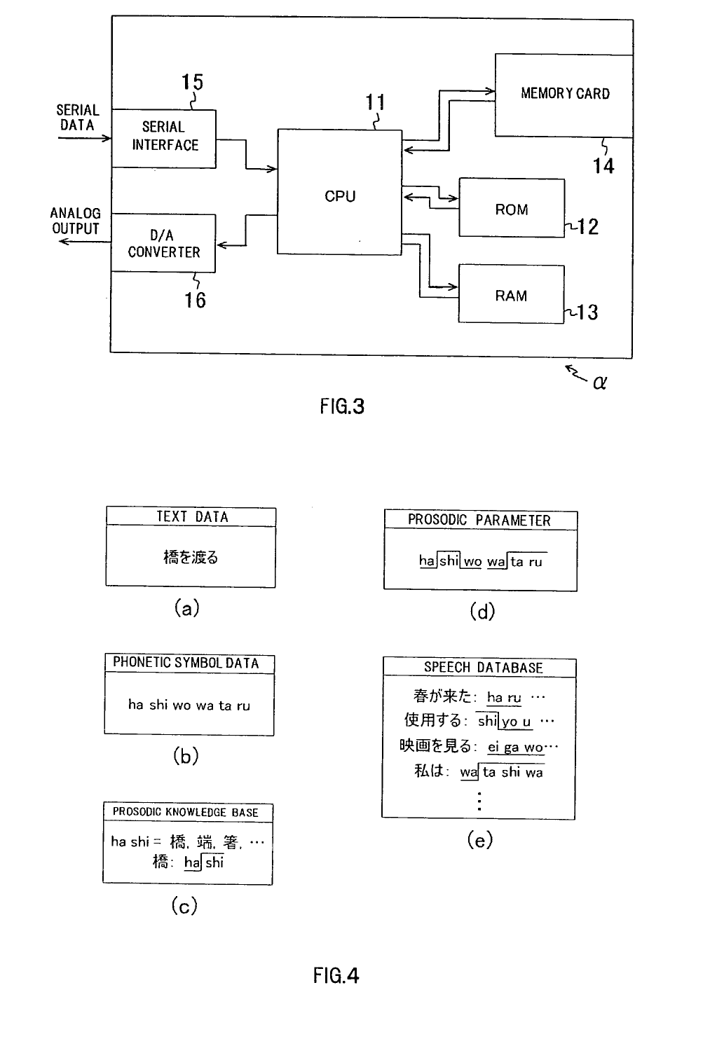

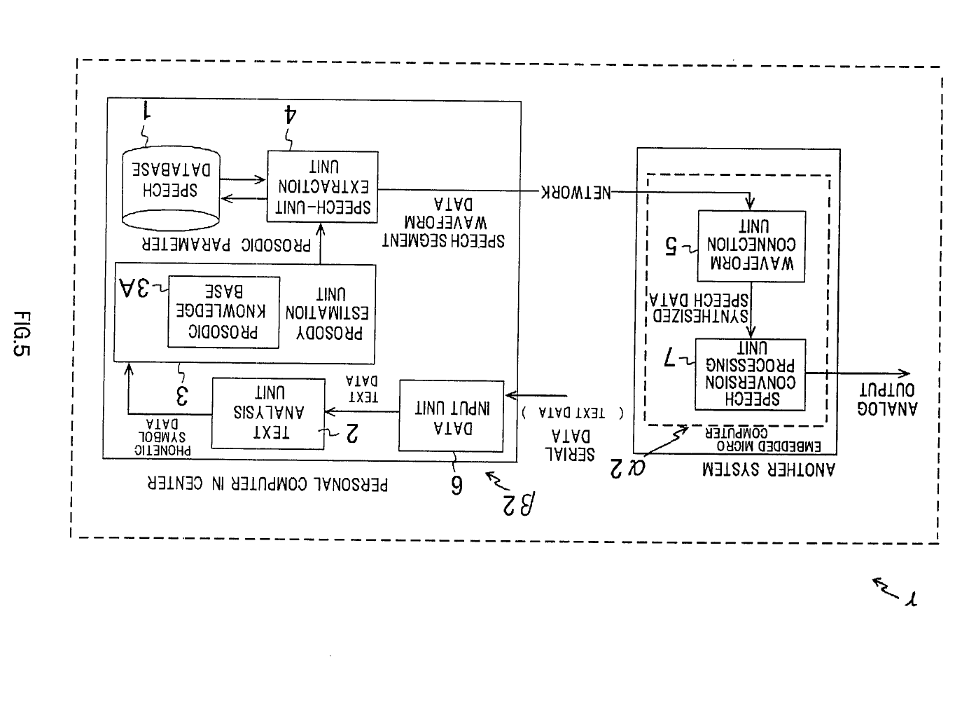

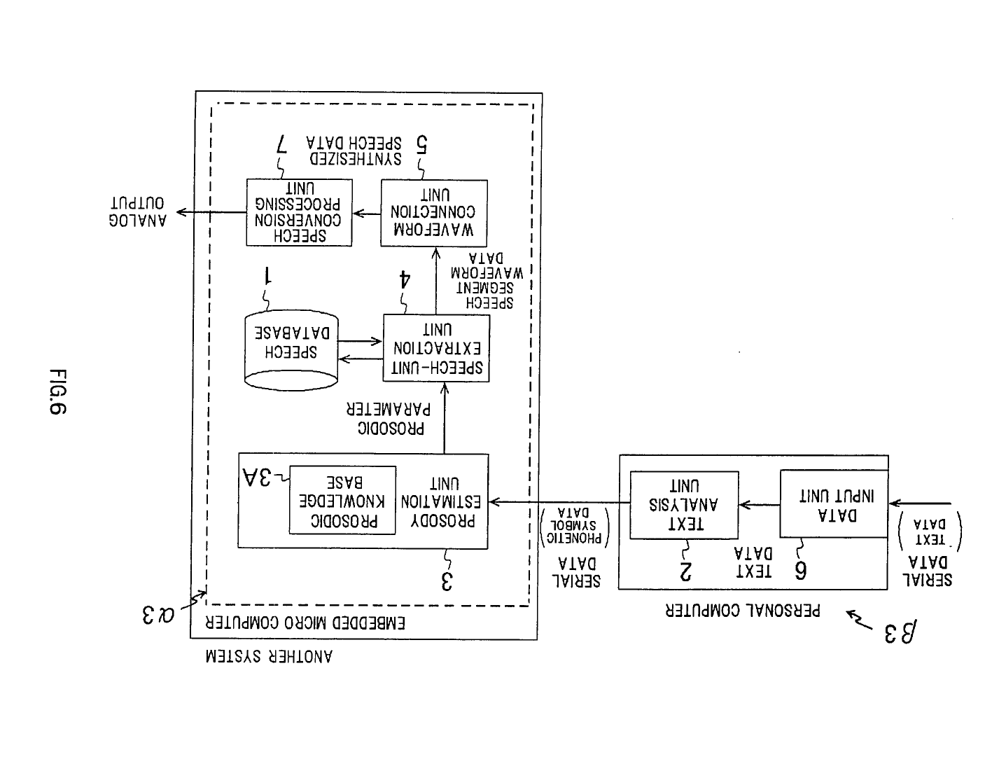

FIGS. 4 (a)-4(e) are diagrams for illustrating the data configuration of the speech synthesizing apparatus α of the particular exemplary form, wherein FIG. 4(a) is a diagram for illustrating text data; FIG. 4(b) for phonetic symbol data; FIG. 4(c) for prosodic knowledge base; FIG. 4(d) for prosodic parameters; and FIG. 4(e) for a speech database. Accents and intonations are schematically shown for illustration.

As shown in FIG. 4(a), the text data input to the text analysis unit 2 is a given sentence such as “ [symbol] ” in the serial data acquired by the data input unit 6, wherein the text data may be mixture of kana-characters, kanji-characters and the like. Any characters which can be converted into a sound may be employed, and characters used for the text data are not limited in any way.

Further, the text data is not limited to a plain text data file. It may be those extracted by eliminating HTML tags from a HTML (Hyper Text Markup Language) data file, and may be text data in a website on the internet or in e-mail, and may be text data which is directly input and created by a user using an input means such as a keyboard or a mouse.

On the other hand, as shown in FIG. 4(b), the phonetic symbol data generated by the text analysis unit 2 employs phonetic symbols representing the sound of the text data by vowels and/or consonants. Thus, for example, the phonetic symbol data generated based on the text data shown in FIG. 4(a) is as follows: “ha shi wo wa ta ru”.

A prosodic knowledge base 3A is a preset rule which used by the prosody estimation unit 3 in order to determine an accent, an intonation and the like of the phonetic symbol data. The prosodic knowledge base 3A has an algorithm for example, for determining from the context whether the phonetic symbol data “ha shi” shown in FIG. 4(b) is corresponding to Japanese “ [symbol] ” or “ [symbol] ” or “ [symbol] ”, whereby the accent and intonation of the phonetic symbol data can be determined.

Thus, the prosody estimation unit 3 is adapted to generate a prosodic parameter for each predetermined speech unit (here, “ha” and “shi”) regarding “ha shi” in the phonetic symbol data corresponding to “ [symbol] ”, for example, based on the prosodic knowledge base 3A. Accents, intonation, a pause between speeches, a speech rhythm, a speech speed, etc. can be determined for all phonetic symbol data based on the prosodic knowledge base 3A.

Here, for explanation of an accents and an intonation, descriptions are given while drawing an under line and an over line over the phonetic symbol. However, any recording system may be employed which enables the speech synthesizing apparatus α to determine the information such as an accent and intonation necessary for the speech.

Furthermore, as shown in FIG. 4(d), the prosodic parameter generated by the prosody estimation unit 3 according to the prosodic knowledge base 3A illustrated in FIG. 4(c) is for indicating an accent, an intonation and a pause between speeches as respective parameters each corresponding to a phonetic symbol so as not to be inconsistent with the context of the text data. For example, a gap between the underlines which respectively indicate accents of “wo” and “wa” represents a pause having a predetermined interval between the phonetic symbols.

Then, as shown in FIG. 4(e), in the speech database 1 which is accessed from the speech-unit extraction unit 4, a natural voice reading a plurality of predetermined sentences are prerecorded together with the speech data associated with the prosodic knowledge base 3A for the accents, intonation and the like, such that the natural voice can be extracted as the speech segment waveform data for each predetermined speech unit such as a phoneme. FIG. 4(e) shows that the speech data including “ [symbol] (ha ru ga ki ta)”, “ [symbol] (si yo u su ru)”, “ [symbol] (ei ga wo mi ru)” and “ [symbol] (wa ta shi wa)” are prerecorded.

Thus, when the speech-unit extraction unit 4 receives a prosodic parameter as shown in FIG. 4(d) from the prosody estimation unit 3, the speech-unit extraction unit 4 retrieves, from speech database 1, “ha”, shi”, “wo”, “wa”, “ta”, and “ru” each having its own accent and intonation indicated by the prosodic parameter; and speech data having corresponding phonetic symbols and the accent and intonation closest thereto.

Subsequently, the speech-unit extraction unit 4 cuts out and extracts the speech segment waveform data “ha”, “shi”, “wo”, “wa”, “ta” and “ru”, which are corresponding to prosodic parameter, from the previously extracted speech data such as “ [symbol] (ha ru ga ki ta)”, “ [symbol] (si yo u su ru)”, “ [symbol] (ei ga wo mi ru)”, “ [symbol] (wa ta shi wa)”, etc. As a result, it becomes possible that the waveform connection unit 5 can smoothly connect the speech segment waveform data and generate synthesized speech data.

In the foregoing, the case where a phoneme is employed as a predetermined speech unit has been described by way of example. However, when input text data contains therein a word or phrase which was prerecorded in the speech database 1, by selecting the word or phrase as the predetermined speech unit, the word or phrase recorded in the speech database 1 can be extracted in the speech-unit extraction unit 4 as it is without dividing it. Thus, the word or phrase can be output as it is or in combination with other word or phrase, whereby more natural speech can be synthesized.

### EMBODIMENTS

Hereinafter, as embodiments, exemplary functional configurations will be described using the functional block diagram shown in FIGS. 1 and 2 and the embodied block diagrams for the speech synthesizing apparatus α of the invention shown in FIGS. 5 and 6.

(Exemplary Configuration 1)

First, As an exemplary functional configuration 1, the speech synthesizing apparatus α which has been described in connection with the aforementioned exemplary form and which comprises the functional units 1 to 7, all of which are shown in the functional block diagram in FIG. 1 and are mounted in a micro computer.

In this case, the speech synthesizing apparatus α has the functional units 1 to 7 all of which are integrally installed in a single casing such that the speech synthesizing apparatus α can perform speech synthesizing by itself without assigning the functions to separate equipment or a separate apparatus, as a result of which a series of functions from serial data input to analog output by the functional units 1 to 7 can be performed by a single casing.

Further, if all of the functions of the functional units can be performed by way of the single casing, the functional configuration thereof is not specifically limited. For example, a speaker (not shown), a data input device (not shown) and the like may be installed in the casing as a speech conversion-and-output unit 7 and a data input unit 6.

(Exemplary Configuration 2)

As an exemplary functional configuration 2, the speech synthesizing apparatus α2 is used which is formed by adding, to the speech synthesizing apparatus α of the exemplary configuration 1, the speech speed conversion unit 8 that provides read speed adjustment function of the synthesized speech, wherein all of the functional units 1 to 8 shown in FIG. 2 are integrally installed in a single casing as is the exemplary configuration 1.

Further, the speech speed conversion unit 8 performs the speed adjustment of the synthesized speech by reflecting a speed parameter to the synthesized speech data. In this case, the text data as well as the speed parameter are input to the data input unit as serial data.

The speed parameter is passed through the functional units from the data input unit 6 to the functional units to the waveform connection unit 5 with the speed parameter being added to the respective conversion data and parameters, and recognized first at the speech speed conversion unit 8. The speech speed conversion unit 8 assigns a speed parameter value to the synthesized speech data which was received together with the speed parameter from the waveform connection unit 5, and changes the read speed of the synthesized speech.

An object of the configuration example 2 is to correctly transmit the synthesized speech to a user by changing the read speed depending on the use thereof by performing the speech speed conversion. For example, setting the read speed lower than usual and making it easy to catch the speech is effective in the condition where it is relatively difficult to calm down and judge a situation, for example, in the event of an emergency.

(Exemplary Configuration 3)

FIG. 5 is a functional block diagram showing an exemplary configuration of a speech synthesizing system γ wherein the waveform connection unit 5 and the speech conversion processing unit 7 of the speech synthesizing apparatus α shown in FIG. 1 are mounted in an embedded micro computer α2 and the remaining functional units are mounted in a separate personal computer, so that a series of speech synthesizing processing is performed.

As shown in FIG. 5, the speech synthesizing system γ of the particular exemplary configuration 3 is one example of a speech synthesizing system to be used as an output terminal used as an emergency alert. This speech synthesized system γ comprises an embedded micro computer α2 wherein text data input for providing information when a disaster such as fire or earthquake occurs is converted into a synthesized speech.

As shown in FIG. 5, the speech synthesizing system γ comprises the embedded micro computer α2 containing therein a waveform connection unit 5 and a speech conversion processing unit 7; and a machine such as a personal computer containing therein a speech database 1 and functional units from a data input unit 6 to a speech-unit extraction unit 4 which are the functional units shown in FIG. 1 and other than those mentioned above, wherein the micro computer α2 and the machine network-connected to each other.

The embedded micro computer α2 may be connected alone to the network, or may be installed in a separate apparatus.

Suitable candidates for network-connecting are: an internet connection and a phone line which can be easily connected in homes or in a small scale equipment; a radio system; a private line; and the like which can provide data-communicate with separate equipment, but not limited thereto.

Among the functional units of the speech synthesizing apparatus α shown in FIG. 1, by assigning high-load and time-consuming functions provided by the functional units from the data input unit 6 to the speech-unit extraction unit 4 to a separate high-speed-processing and high-capacity personal computer β2 machine, and merely converting the speech segment waveform data, which the embedded micro computer α2 is received from the personal computer β2 through a network, to synthesized speech data, a beneficial effect that high-speed speech synthesis processing can be provided is brought out, even when urgent attention is required.

The exemplary configuration 2 may be applied not only for emergency alert, but also for guide and notification. Further, by incorporating the speech speed conversion unit 8 shown in the exemplary configuration 2 in the exemplary configuration 3, the read speed can be changed depending on the situation.

(Exemplary Configuration 4)

FIG. 6 is a functional block diagram, similar to FIG. 5, of an embedded micro computer α3 in which the functional units 1, 3-5 and 7 of the speech synthesizing apparatus α shown in FIG. 1 are incorporated.

As shown in FIG. 6, the embedded micro computer α3 according to the exemplary configuration 4 is a micro computer which is adapted to acquire phonetic symbol data from a given personal computer β3 in which the data input unit 6 and the text analysis unit 2 are incorporated, wherein the embedded micro computer α3 comprises a series of the functional units, for outputting synthesized speech, from the prosody estimation unit 3 to the speech conversion processing unit 7. After initial setup, the personal computer β3 is separated.

The embedded micro computer α3 is provided for being installed in a small device such as a toy or other apparatuses. The apparatuses in which the embedded micro computer α3 is installed include a toy, a mobile phone, a medical and welfare device such as a hearing aid, and the like.

While the foregoing apparatuses can provide users with synthesized speeches, the contents of input serial data are relatively settled. However, a prior text analysis can enhance processing efficiency.

Further, such a microprocessor can be installed in not only small devices as mentioned above, but also apparatuses such as a vending machine, a car navigation system, a unmanned reception desk and the like whose synthesized speech contents to be output is limited. In such a case, the speech synthesizing function can be imparted to such apparatuses only by additionally installing therein the embedded micro computer α3 without newly providing large equipment.

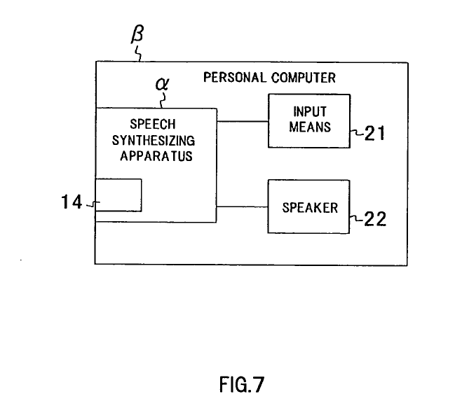

Further, FIG. 7 is a schematic view showing an exemplary hardware configuration wherein the speech synthesizing apparatus α illustrated as the particular exemplary form in a personal computer β that is a separate apparatus.

As shown in FIG. 7, when the speech synthesizing apparatus α is installed in a given personal computer P and connected thereto, it becomes possible to cause a speaker 22 to speech-output, for example, by causing the data input unit 6 to receive serial data from an input means 21 mounted in the personal computer β, and analog-outputting from the speech conversion processing unit 7 the synthesized speech data generated by the speech synthesizing apparatus α based on the serial data to the speaker 22 which is incorporated in the personal computer β and can output a speech.

At this time, it is desirable that the speech synthesizing apparatus α contains therein the memory card 14 for prerecording the speech database 1. The memory card 14 may be preliminarily installed in the speech synthesizing apparatus α in a fixed and dedicated manner or may be replaceable with another memory card 14 as desired by user who uses the personal computer β.

While the embodiments of the invention have been described in terms of an exemplary form and exemplary functional configurations of the speech synthesizing apparatus α, it should be understood that the present invention is not necessarily limited thereto. It will be apparent to those skilled in the art that various modifications can be made to the present invention without departing from the scope of the invention.

Further, by connecting the speech synthesizing apparatus α to another separate speech recognizer, interactive speech synthesizing apparatuses can be provided which enable a conversation with natural vocalization.

1. A speech synthesizing apparatus which is provided with a speech database which selectively stores plural kinds of prerecorded speech data of predetermined sentences such that the speech data can be extracted as speech segment waveform data for each predetermined speech unit depending on a user's application from voice data which has been obtained by recording a predetermined sentence with a natural human voice as a speech sentence and then converting the voice data into digital data, and which is provided for performing corpus-based speech synthesis based on a speech database with respect to a given text data, the speech synthesizing apparatus comprising:
a data input unit for acquiring text data from serial data;
a text analysis unit for processing the sentence in the text data so as to represent sounds corresponding to the sentence by phonetic symbols of vowels and consonants and generating phonetic symbol data of the sentence;
a prosody estimation unit for generating a prosodic parameter representing an accent and an intonation corresponding to each phonetic symbol data corresponding to a given sentence in the text data which was analyzed beforehand according to a preset prosodic knowledge base for accents and intonations;
speech-unit extraction unit for extracting all the speech segment waveform data of an associated predetermined speech unit part from each speech data having the predetermined speech unit part closest to the prosodic parameter generated by the prosody estimation unit, based on a speech database which stores therein plural kinds of predetermined selectively prerecorded speech data only such that the speech database has a predetermined speech unit suitable for a specific application of the speech synthesizing apparatus;
a waveform connection unit for generating synthesized speech data by performing, in a sequence of the sentences, sequentially successive waveform connection of the speech segment waveform data groups extracted by the speech-unit extraction unit such that the speech waveform of the speech segment waveform data groups continues; and
speech conversion processing unit for converting the synthesized speech data to analog sounds and outputting the analog sounds
wherein:
the speech database is assembled on a memory card which can be removably mounted to the speech synthesizing apparatus, and when the memory card is mounted to the speech synthesizing apparatus, the memory card can be read from the speech0unit extraction unit, and
the data input unit is connected to a separate apparatus in which the speech synthesizing apparatus is incorporated and receives serial data from the separate apparatus.

2.-3. (canceled)

4. The speech synthesizing apparatus according to claim 1, wherein the synthesizing apparatus reflects a speed parameter acquired together with the given sentence from the data input unit to the synthesized speech data generated by the waveform connection unit, and a speech speed conversion unit for adjusting a read speed of the synthesized speech data is placed upstream from the speech conversion processing unit.

5. The speech synthesizing apparatus according to claim 1,
wherein the data input unit, the text analysis unit, the prosody estimation unit, the speech database, the speech-unit extraction unit, the waveform connection unit, and the speech conversion processing unit are integrally installed in a single casing.

6.-7. (canceled)

8. The speech synthesizing apparatus according to claim 1, wherein the predetermined speech unit is one or more of a phoneme, a word, a phrase and a syllable.

9.-11. (canceled)

12. The speech synthesizing apparatus according to claim 1, wherein any one functional unit of the data input unit, the text analysis unit, the prosody estimation unit, the speech database, the speech-unit extraction unit, the waveform connection unit and the speech conversion processing unit is selectively extracted depending on the application and mounted in an embedded computer which is installed in a separate apparatus.
